(19) United States
(12) Patent Application Publication
(10) Pub. No.: US 2006/0012145 A1
(43) Pub. Date: Jan. 19, 2006

(54) Wheel assembly for a trailer

(76) Inventor: Steward E. Gardner, Bristol, IN (US)

Correspondence Address: R. TRACY CRUMP, P.O. BOX 604, 32790 DUNN ROAD, NEW CARLISLE, IN, 46552, US

(21) Appl. No.: 11/181,361

(22) Filed: Jul. 14, 2005

Related U.S. Application Data
(60) Provisional application No. 60/588,055, filed on Jul. 16, 2004.

(51) Int. Cl. B60G 21/05

(52) U.S. Cl. 280/124.128

(57) ABSTRACT

The wheel assembly of this invention eliminates the problem associated with solid cross axles in pull behind trailers, and includes a sturdy fender and a wheel mount pivotally connected to the fender within the wheel well. The wheel mount is suspended by a leaf spring also mounted to the fender within the wheel well. The fender provides the structural support of each wheel assembly and is simply mounted to the trailer frame. The wheel assemblies are mounted directly to the side of the trailer frame, instead of under the trailer frame, which lowers the trailer floor without compromising ground clearance. Since each wheel mount is independently suspended within the wheel well, the trailer rides smoother over rough ground and trailers with less road sway and yaw.

This invention relates to a wheel assemblies for use in pull behind trailers and various other types of trailers and vehicles.

### BACKGROUND OF THE INVENTION

Pull behind trailers have been adapted for a variety of uses and application. The basic pull behind trailer design employs a trailer frame built atop a solid axle wheel assembly. While simple and sturdy, the cross axle wheel assembly used in conventional trailers has several disadvantages.

Building the trailer frames atop the wheel assembly raises the center of gravity of the trailer. The higher the center of gravity, the more prone to road sway and yaw the trailer becomes. Excessive sway and yaw can cause a trailer to overturn even at low speeds on straight and level roads. Lowering the center of gravity makes the trailer ride smoother and more safely. While lowering the center of gravity is desirable, ground clearance is also a concern for pull behind trailers. Cross axles and trailer frames can be damaged from road debris. With solid cross axle wheel assemblies, ground clearance can only be improved by increasing the size of the trailer wheels. Furthermore, it is desirable in many applications to lower the trailer floor to facilitate loading of the trailer. Since the trailer frame is built atop a solid cross axle wheel assembly, the trailer floor can not be lowered without compromising ground clearance. Consequently, it is desirable to develop a pull behind trailer and wheel assembly that eliminates the cross axles for improved center of gravity, ground clearance and floor height.

### SUMMARY OF THE INVENTION

The wheel assembly of this invention eliminates the problems associated with solid cross axles in pull behind trailers. The wheel assembly of this invention includes a sturdy fender and a wheel mount pivotally connected to the fender within the wheel well. The wheel mount is suspended by a leaf spring also mounted to the fender within the wheel well. The fender provides the structural support of each wheel assembly and is simply mounted to the trailer frame. The wheel assemblies are mounted directly to the side of the trailer frame, instead of under the trailer frame, which lowers the trailer floor without compromising ground clearance. Since each wheel mount is independently suspended within the wheel well, the trailer rides smoother over rough ground and with less road sway and yaw.

Accordingly, an advantage of this invention is that the wheel assembly eliminates the need for a solid cross axle on a pull behind trailer.

Another advantage is that each wheel assembly has independent suspension for an improved trailer ride.

Another advantage of this invention is that the wheel assembly reduces the center of gravity of the trailer to improve the ride and reduce road sway and yaw.

Another advantage is that the wheel assembly improves the ground clearance of the trailer.

Another advantage is that the wheel assembly lowers the trailer floor for more convenient loading.

Other advantages will become apparent upon a reading of the following description.

### BRIEF DESCRIPTION OF THE DRAWINGS

A preferred embodiment of the invention has been depicted for illustrative purposes only wherein:

FIG. 1 is a perspective view of the typical pull behind trailer using the wheel assembles of this invention;

FIG. 2 is a perspective view of the wheel assembly with the trailer deck outlined in shadow;

FIG. 3 is an exploded view of the wheel assembly of this invention;

FIG. 4 is a partial sectional side view of the wheel assembly of this invention;

FIG. 5 is a partial side sectional view of the wheel assembly of this invention illustrating the pivotal suspension of the wheel mount;

FIG. 6 is back sectional view of a conventional trailer using a traditional solid axle wheel assembly;

FIG. 7 is a back sectional view of the trailer of FIG. 1;

FIG. 8 is side view of a wheel assembly with a tall fender for normal ground clearance;

FIG. 9 is a side view of a wheel assembly with a shorter fender for greater ground clearance; and

FIG. 10 is a partial side view of a trailer using a wheel assembly of this invention with tandem wheel mounts.

### DESCRIPTION OF THE PREFERRED EMBODIMENT

The preferred embodiments herein described are not intended to be exhaustive or to limit the invention to the precise form disclosed. They are chosen and described to best explain the invention so that others skilled in the art might utilize its teachings.

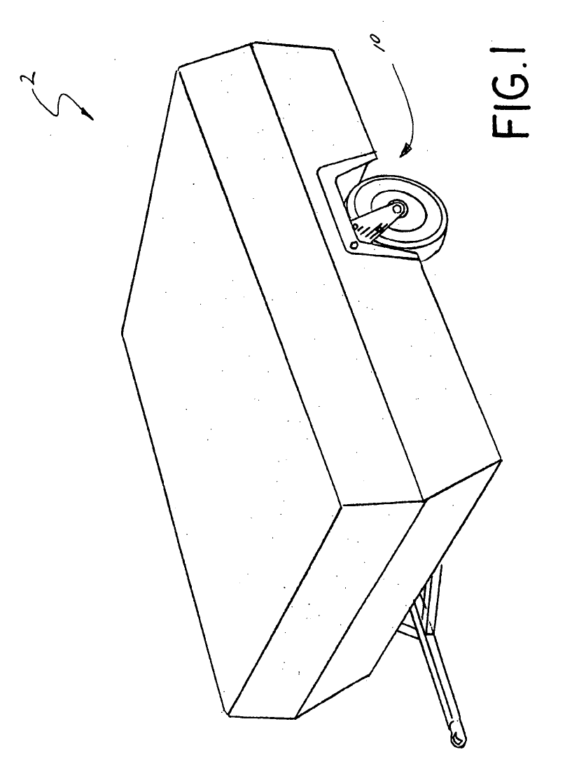

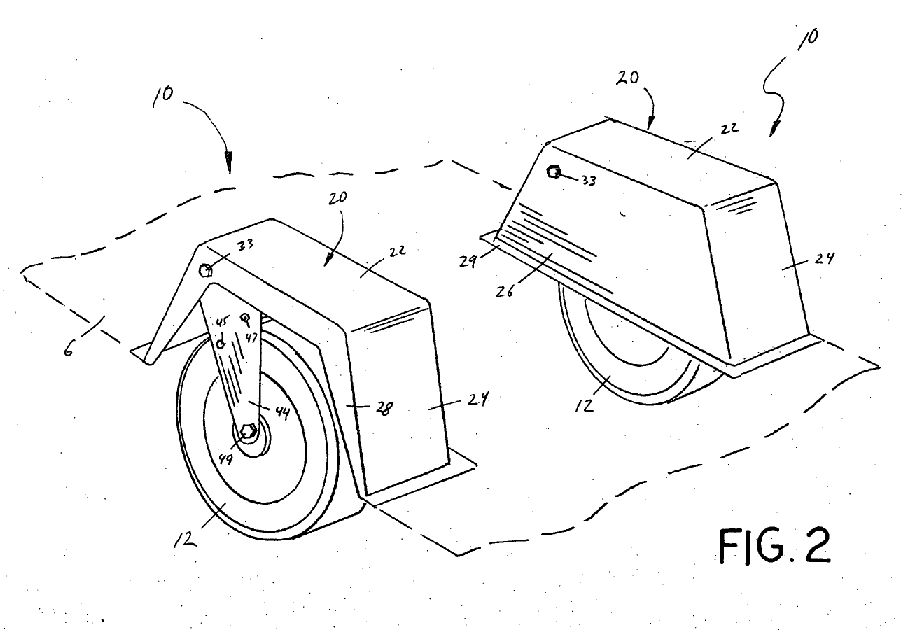

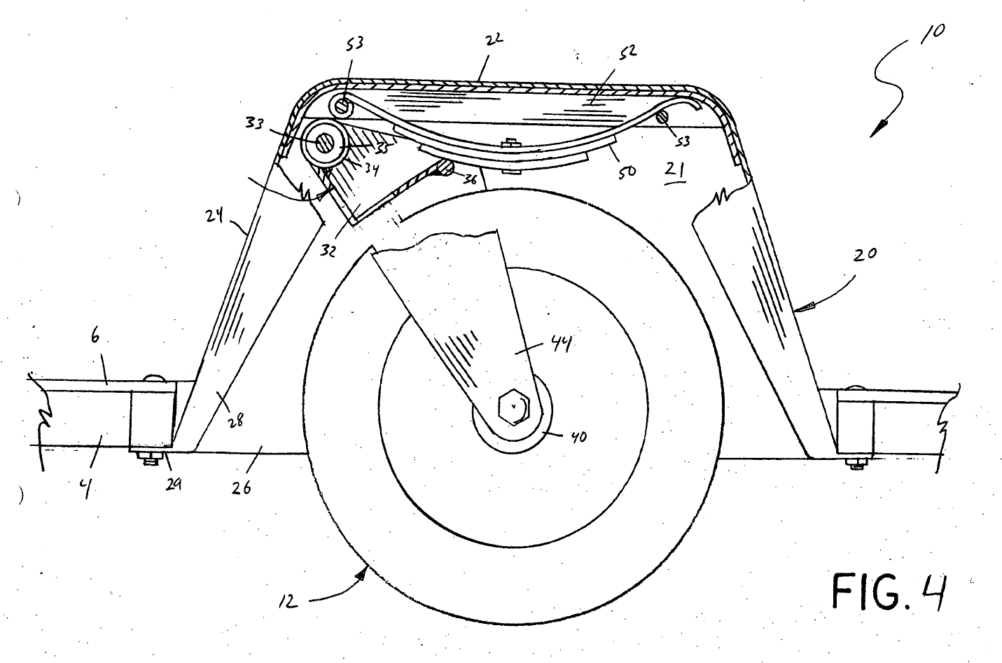

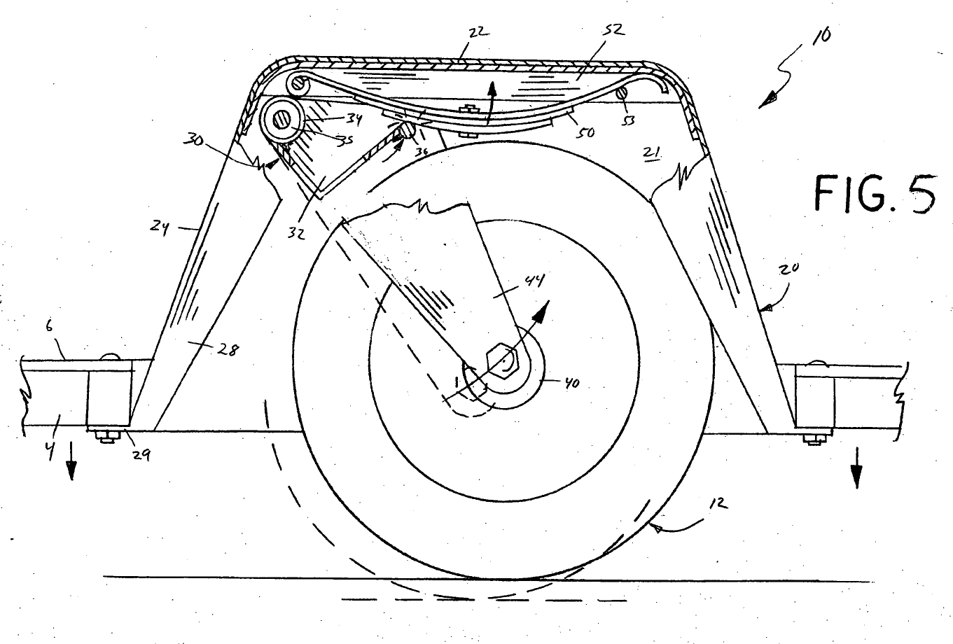

FIGS. 1-5 illustrate a typical pull behind trailer 2 using the wheel assemblies 10 of this invention. Trailer 2 includes a frame 4 and a floor 6. As shown in FIG. 2, two separate wheel assemblies 10 are mounted to each side of trailer frame 4. The wheel assembly of this invention is designed for use with all types of light duty pull behind trailers, but may be modified within the scope of this invention for uses with other trailer applications. The trailer depicted in the figures is selected solely for illustrative purposes and is not intended to limit the application of wheel assembly 10 to any particular type or style of trailer.

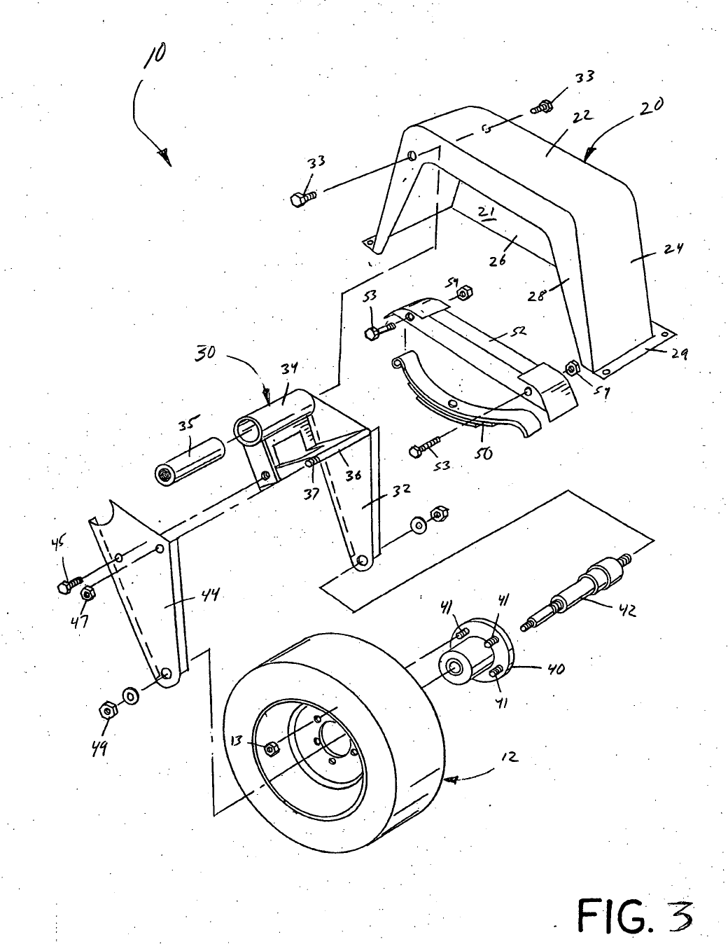

As shown in FIGS. 3-5, wheel assembly 10 includes a fender 20, pivoting wheel mount 30 and a leaf spring 50. Wheel mount 30 and leaf spring 50 are built into the wheel well 21 of fender 20, which provides the support structure for the wheel assembly. Fender 20 is stamped or formed of a sturdy sheet metal to have a top 22, leading wall 24, a trailing wall 25, a back wall 26 and a side flaring 28. The fender 20 is shaped to form a wheel well 21. Fender 20 also includes mounting flanges 29 that allow the fender to be bolted to the sides of trailer frame 4.

Wheel mount 30 includes a rear swing arm 32, a bearing hub 40, an axle shaft 40 and a removable brace plate 44. As shown, swing arm 32 is pivotally connected to fender 20 between back wall 26 and side flaring 28 adjacent leading wall 24. Bolts 33 are turned into a bushing 35 that is journalled within a collar 34 extending from the swing arm. Swing arm 32 also has a stop bar 36, which terminates in a protruding threaded end 37. A bearing hub 40 turns on an axle shaft 42, which extends from swing arm 32. The trailer wheel 12 is mounted to bearing hub 40 and secured by nuts 13 turned onto the lugs 41 of bearing hub 40. One end of brace plate 44 is bolted to swing arm 32 by a bolt 45, which is turned in to a threaded bore in swing arm 32 and a nut 47, which is turned onto threaded stop end 37. The other end of brace plate 44 is secured to the axle shaft 42 by nut 49. Removable brace plates 44 provide structural rigidity to wheel mount 30, and allow wheels 12 to be readily removed for tire repair.

Leaf spring 50 insulates wheel mount 30 from shocks transmitted through wheel 12. While wheel assembles 10 is illustrated using a conventional leaf spring, other suspension mechanisms may be incorporated into the design of the wheel assembly, such as, but not limited to air shocks, elastomers, and coil springs. Leaf spring 50 is seated inside a channel 52 and secured to fender 20 by bolts 53. Leaf spring 50 is positioned within wheel well 21 so that stop bar 36 of swing arm 32 rests against the leaf spring to provide a suspension ride for trailer 10. Channel 52 has two end plates 54, which protect the fender body from wear as leaf spring 50 flexes with the movement of wheel mount 30. Channel 52 reenforces fender top 22 and skid plates 54 prevent wearing on the fender body.

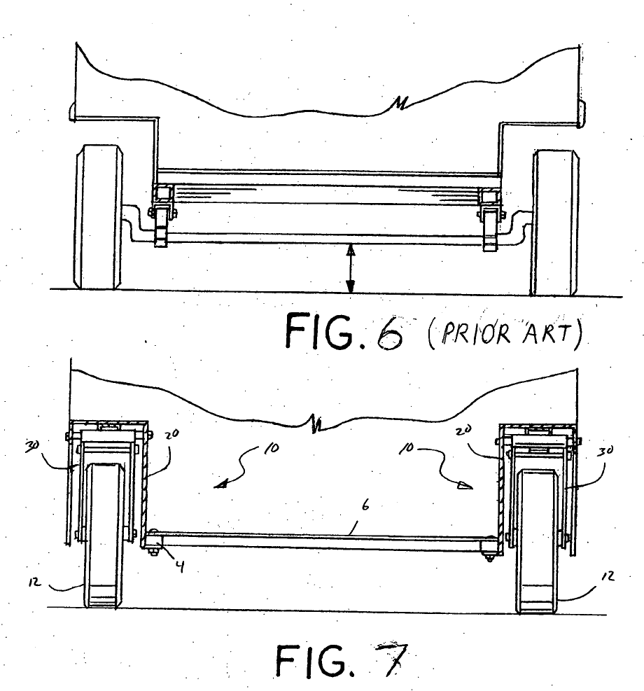

FIGS. 6-10 illustrate several advantages of wheel assembly 10 of this invention over traditional solid axle assemblies used on pull behind trailers. FIG. 6 shows a conventional solid cross ale wheel assembly of a pull behind trailer where the trailer floor is supported above the cross axle. As such, the height of the trailer floor is above the axle. The height of the axle also dictates the ground clearance of the trailer. FIG. 7 shows a pull behind trailer using the wheel assembly 10 of this invention. With no solid cross axle, the height of the trailer floor is limited only by the desired ground clearance.

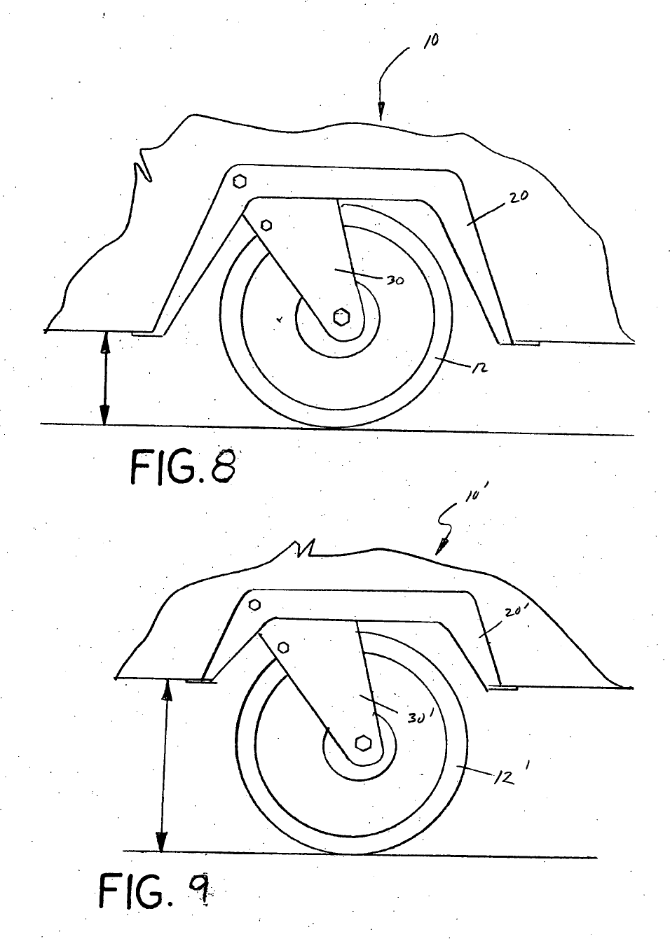

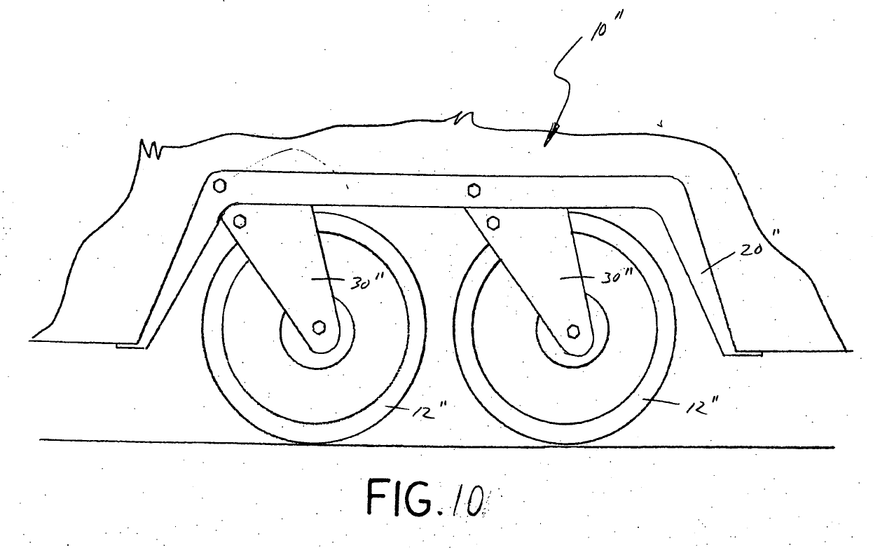

As shown in FIGS. 8 and 9, wheel assembly 10 can be modified to vary the ground clearance of the trailer by changing the height of the fender or the location where the fenders are mounted to the trailer frames. Shorter fenders provide greater ground clearance, while taller fenders lower the trailer deck for more convenient loading. Mounting the fenders higher on the trailer frames lower the height of the trailer floors and reduce ground clearance. Mounting the fenders lower on the trailer frames raises the floor height and increases the ground clearance. Since the wheel assembly is mounted to the side of the trailer frame, instead of under the frame, the trailer has a lower center of gravity. In addition, each wheel assembly has its own suspension mechanism via the leaf spring, which provide independent suspension from the other wheel assembly. The independent suspension and the lower center of gravity provided by the wheel assembly of this invention improves the ride of the trailer and reduces road sway and yaw.

FIG. 10 illustrates a wheel assembly with tandem independent wheel mounts for use with heavy load pull behind trailers, Each of the pivotal wheel mount in the wheel assembly has its own leaf spring suspension built into the fender. The tandem wheel mounts provide more load bearing capacity, while not affecting the independent suspension of the wheel assemblies.

It is understood that the above description does not limit the invention to the details given, but may be modified within the scope of the following claims.

I claim:

1: A wheel assembly comprising:
a fender defining a wheel well;
a wheel;
a wheel mount pivotally connected to the fender within the wheel well for rotatably supporting the wheel within the wheel well; and
suspension means mounted to fender within the wheel well for insulating the wheel mount from shocks transmitted through the wheel.

2: The wheel assembly of claim 1 wherein the wheel mount includes a swing arm, an axle shaft extending from the swing arm and a wheel hub rotating on the axle shaft for securing the wheel to the swing arm.

3: The wheel assembly of claim 2 wherein the fender includes a leading wall, a top wall, a trailing wall, a back wall and a side flaring,
the swing arm is pivotally connected between the back wall and the side flaring adjacent the leading wall so that the wheel mount extends away from the leading wall into the wheel well.

4: A pull behind trailer comprising: a trailer floor; and a pair of wheel assemblies mounted to opposite sides of the trailer floor,
each of the wheel assemblies including a fender mounted defining a wheel well, a wheel, a wheel mount pivotally connected to the fender within the wheel well for rotatably supporting the wheel within the wheel well, and suspension means mounted to fender within the wheel well for insulating the wheel mount from shocks transmitted through the wheel.

5: The trailer of claim 4 wherein the wheel mount includes a swing arm, an axle shaft extending from the swing arm and a wheel hub rotating on the axle shaft for securing the wheel to the swing arm.

6: The trailer of claim 5 wherein the fender of each wheel assembly is mounted to the trailer floor so that wheel hub is suspended within the wheel well above the trailer floor.
